(19) United States
(12) Patent Application Publication
(10) Pub. No.: US 2025/0299855 A1
(43) Pub. Date: Sep. 25, 2025

(54) Soft Magnetic Powder, Dust Core, Magnetic Element, And Electronic Device

(71) Applicant: SEIKO EPSON CORPORATION, Tokyo (JP)

(72) Inventors: Takayuki MURAI, Hachinohe (JP); Mayu WATANABE, Hachinohe (JP)

(21) Appl. No.: 19/084,869

(22) Filed: Mar. 20, 2025

(30) Foreign Application Priority Data
Mar. 21, 2024 (JP) 2024-045460

(51) Int. Cl. H01F 1/147; H01F 1/28

(52) U.S. Cl. CPC H01F 1/14766; H01F 1/28

(57) ABSTRACT

A soft magnetic powder includes: impurities and a composition represented by a composition formula FeₓCuₐNb_{b}(Si_{1-y}(B_{1-z}Cr_{z})_{y})_{100-x-a-b} [a, b, x, y, and z satisfy 0.3≤a≤2.0, 2.0≤b≤4.0, 75.5≤x≤79.5, 0.55≤y≤0.91, and 0.015≤z≤0.185]. The soft magnetic powder has an average particle diameter of 5.0 μm or more and 45.0 μm or less, and has a crystallite diameter of 5.0 nm or more and 20.0 nm or less, as measured by an X-ray diffraction method, and a reduction rate d of permeability is 3.0% or less, as represented by the following equation:

$$d = \vert {μ}_{1} - {μ}_{100} \vert / {μ}_{1} \times 100$$

in the above equation, μ₁ is permeability measured at a frequency of 1 MHz, and μ₁₀₀ is permeability measured at a frequency of 100 MHz.

The present application is based on, and claims priority from JP Application Serial Number 2024-045460, filed Mar. 21, 2024, the disclosure of which is hereby incorporated by reference herein in its entirety.

### BACKGROUND

### 1. Technical Field

The present disclosure relates to a soft magnetic powder, a dust core, a magnetic element, and an electronic device.

### 2. Related Art

JP-A-2022-175110 discloses a soft magnetic powder including amorphous metal particles having a composition represented by a composition formula Fe_{100-a-b-c-d-e-f-g}CrₐSi_{b}B_{c}C_{d}AlₑTi_{f}Co_{g} (where a, b, c, d, e, f, and g are numbers representing atomic % and satisfy 0<a≤3.0, 5.0<b≤15.0, 7.0≤c≤15.0, 0.1≤d≤3.0, 0<e≤0.016, 0<f≤0.009, and 0≤g≤0.025). According to such a configuration, it is possible to obtain a soft magnetic powder that has good magnetic properties due to an amorphous alloy and also has low coercive force.

JP-A-2022-175110 discloses that a heat treatment is performed in the production of the soft magnetic powder. By performing the heat treatment, it is possible to reduce various defects and anisotropy (stress-induced anisotropy) that are introduced during the production of the soft magnetic powder. Accordingly, the low coercive force can be achieved. Further, JP-A-2022-175110 discloses that a heating temperature in the heat treatment is set to a temperature lower than a crystallization temperature of the amorphous metal particles.

However, from the viewpoint of further reducing the coercive force, a method for producing the soft magnetic powder described in JP-A-2022-175110 still has room for improvement. For example, even when the heat treatment is performed, the coercive force of some particles may not sufficiently decrease. Therefore, the implementation of a soft magnetic powder that reliably achieves a low coercive force is a challenge.

A decrease in a green compact density and a decrease in DC superimposition characteristics due to oxidation cause operational stability of a magnetic element using the green compact to decrease.

Therefore, the implementation of a soft magnetic powder that can be used to produce a green compact having excellent oxidation resistance, density, coercive force, and DC superimposition characteristics is a challenge.

### SUMMARY

A soft magnetic powder according to an application example of the present disclosure includes:
impurities and a composition represented by a composition formula FeₓCuₐNb_{b} (Si_{1-y}(B_{1-z}Cr_{z})_{y})_{100-x-a-b} in terms of atomic ratio, where a, b, x, y, and z satisfy 0.3≤a≤2.0, 2.0≤b≤4.0, 75.5≤x≤79.5, 0.55≤y≤0.91, and 0.015≤z≤0.185, wherein
the soft magnetic powder has an average particle diameter of 5.0 μm or more and 45.0 μm or less, and a crystallite diameter of 5.0 nm or more and 20.0 nm or less, as measured by an X-ray diffraction method, and
when the soft magnetic powder is mixed with 2.0 mass % of an epoxy resin and an obtained mixture is press-molded at a pressure of 294.2 MPa (3 t/cm²) to obtain a ring-shaped first molded body having an outer diameter of 14 mm, an inner diameter of 8 mm, and a thickness of 3 mm, and then a conductive wire having a wire diameter of 0.6 mm is wound seven times around the first molded body to prepare a first specimen, a reduction rate d of permeability is 3.0% or less, as represented by the following equation:

$$d = \vert {μ}_{1} - {μ}_{100} \vert / {μ}_{1} \times 100$$

[In the above equation, μ₁ is permeability of the first specimen measured at a frequency of 1 MHz, and μ₁₀₀ is permeability of the first specimen measured at a frequency of 100 MHz.]

A dust core according to an application example of the present disclosure includes:
the soft magnetic powder according to the application example of the present disclosure.

A magnetic element according to an application example of the present disclosure includes:
a dust core according to the application example of the present disclosure.

An electronic device according to an application example of the present disclosure includes:
the magnetic element according to the application example of the present disclosure.

### BRIEF DESCRIPTION OF THE DRAWINGS

FIG. 1 is an example of a DSC curve obtained from a metal powder according to an embodiment.

FIG. 2 is a plan view schematically showing a toroidal type coil component.

FIG. 3 is a transparent perspective view schematically showing a closed magnetic circuit type coil component.

FIG. 4 is a perspective view showing a configuration of a mobile personal computer which is an electronic device according to the embodiment.

FIG. 5 is a plan view showing a configuration of a smartphone which is an electronic device according to the embodiment.

FIG. 6 is a perspective view showing a configuration of a digital still camera which is an electronic device according to the embodiment.

### DESCRIPTION OF EMBODIMENTS

Hereinafter, a soft magnetic powder, a metal powder, a dust core, a magnetic element, and an electronic device according to the present disclosure will be described in detail based on a preferred embodiment shown in the accompanying drawings.

### 1. Soft Magnetic Powder

The soft magnetic powder according to the embodiment is a metal powder exhibiting soft magnetism. The soft magnetic powder can be applied to various uses, for example, production of various green compacts such as a dust core and an electromagnetic wave absorber by binding particles together with a binder.

A soft magnetic powder according to the embodiment is formed of impurities and a composition represented by a composition formula FeₓCuₐNb_{b}(Si_{1-y}(B_{1-z}Cr_{z})_{y})_{100-x-a-b} in terms of atomic ratio, where a, b, x, y, and z satisfy 0.3≤a≤2.0, 2.0≤b≤4.0, 75.5≤x≤79.5, 0.55≤y≤0.91, and 0.015≤z≤0.185.

The soft magnetic powder according to the embodiment has an average particle diameter of 5.0 μm or more and 45.0 μm or less.

Further, the soft magnetic powder according to the embodiment has a crystallite diameter of 5.0 nm or more and 20.0 nm or less as measured by an X-ray diffraction method.

In such a soft magnetic powder, the oxidation resistance of the soft magnetic powder is enhanced mainly by adding an optimum amount of Cr (chromium). As a result, when the soft magnetic powder is compacted, it is possible to prevent a decrease in a density of the green compact caused by the oxide. In addition, by optimizing an addition amount of each element, the crystallite diameter in the soft magnetic powder is controlled so as not to be too small or too large. As a result, an increase in the coercive force of the soft magnetic powder can be prevented.

The soft magnetic powder according to the embodiment is a powder that, when compacted together with a binder to prepare a ring-shaped first molded body, causes permeability of the first molded body to satisfy a predetermined value. The permeability is evaluated as follows.

First, an epoxy resin in an amount equivalent to 2.0 mass % of the soft magnetic powder according to the embodiment is mixed with the soft magnetic powder, and the obtained mixture is press-molded at a pressure of 294.2 MPa (3 t/cm²). Accordingly, the first molded body is obtained which is in a shape of a ring having an outer diameter of 14 mm, an inner diameter of 8 mm, a thickness of 3 mm and a relative density of 66%. The relative density is a relative value obtained by dividing the density, which is calculated by dividing a mass of the first molded body by the volume, by a true density of the soft magnetic powder. Next, a conductive wire having a wire diameter of 0.6 mm is wound seven times around the first molded body to prepare a first specimen. Next, the permeability of the first specimen is measured at a frequency of 1 MHz and a frequency of 100 MHz. In the soft magnetic powder according to the embodiment, a reduction rate d of the permeability, represented by the following equation, is 3.0% or less.

$$d = \vert {μ}_{1} - {μ}_{100} \vert / {μ}_{1} \times 100$$

[In the above equation, μ₁ is the permeability of the first specimen measured at the frequency of 1 MHz, and μ₁₀₀ is the permeability of the first specimen measured at the frequency of 100 MHz.]

According to the configuration, in a magnetic element manufactured using a soft magnetic powder, magnetic saturation is unlikely to occur even when a DC current is superimposed on coils. Therefore, by using the soft magnetic powder according to the embodiment, it is possible to produce a magnetic element having good DC superimposition characteristics and excellent operational stability.

The soft magnetic powder according to the embodiment will be described in detail below.

### 1.1. Composition

Fe (iron) greatly affects basic magnetic properties and mechanical properties of the soft magnetic powder according to the embodiment.

The content x of Fe is 75.5 atomic % or more and 79.5 atomic % or less, preferably 76.0 atomic % or more and 78.5 atomic % or less, and more preferably 76.5 atomic % or more and 78.0 atomic % or less. When the content x of Fe is less than the lower limit value, a saturation magnetic flux density of the soft magnetic powder decreases. On the other hand, when the content x of Fe is more than the upper limit value, an amorphous structure cannot be stably formed during the production of the soft magnetic powder, resulting in an excessively large crystallite diameter and an increase in coercive force.

When the soft magnetic powder according to the embodiment is produced from raw materials, Cu (copper) tends to separate from Fe. Therefore, the containing of Cu causes a fluctuation in the composition, resulting in regions within the particles that are likely to be crystallized. As a result, precipitation of an Fe phase of a body-centered cubic lattice which is crystallized with relative ease is promoted, and crystal grains having the above-described crystallite diameter tend to be formed.

The content a of Cu is 0.3 atomic % or more and 2.0 atomic % or less, preferably 0.5 atomic % or more and 1.5 atomic % or less, and more preferably 0.7 atomic % or more and 1.3 atomic % or less. When the content a of Cu is less than the lower limit value, the refinement of crystal grains is impaired, and the crystal grains having the crystallite diameter within the above-described range cannot be formed. On the other hand, when the content a of Cu is more than the upper limit value, the mechanical properties of the soft magnetic powder decrease and the soft magnetic powder becomes brittle.

When a material containing a large amount of amorphous structure is subjected to a heat treatment, Nb (niobium) contributes to the refinement of the crystal grains together with Cu. Therefore, the crystal grains having the above-described crystallite diameter are easily formed.

The content b of Nb is 2.0 atomic % or more and 4.0 atomic % or less, preferably 2.5 atomic % or more and 3.5 atomic % or less, and more preferably 2.7 atomic % or more and 3.3 atomic % or less. When the content b of Nb is less than the lower limit value, the refinement of crystal grains is impaired, and the crystal grains having the crystallite diameter within the above-described range cannot be formed. On the other hand, when the content b of Nb is more than the upper limit value, the mechanical properties of the soft magnetic powder decrease and the soft magnetic powder becomes brittle. In addition, the permeability of the soft magnetic powder decreases.

Silicon (Si) promotes amorphization when the soft magnetic powder according to the embodiment is produced from a raw material. Therefore, when the soft magnetic powder according to the embodiment is produced, a homogeneous amorphous structure is first formed, and then, by crystallizing the amorphous structure, crystal grains having a more uniform crystallite diameter are easily formed. The uniform crystallite diameter contributes to averaging out magnetocrystalline anisotropy in each of crystal grains, thereby reducing the coercive force and enhancing the permeability, which contributes to improving the soft magnetic properties.

B (boron) promotes the amorphization when the soft magnetic powder according to the embodiment is produced from a raw material. Therefore, when the soft magnetic powder according to the embodiment is produced, a homogeneous amorphous structure is first formed, and then, by crystallizing the amorphous structure, crystal grains having a more uniform crystallite diameter are easily formed. As a result, the coercive force can be reduced, the permeability can be enhanced, and the soft magnetic properties can be improved. In addition, by using Si and B in combination, the amorphization can be synergistically promoted based on a difference in an atomic radius between Si and B.

In addition, Cr enhances oxidation resistance of the soft magnetic powder. Accordingly, when the soft magnetic powder is compacted, it is possible to prevent a decrease in a density of the green compact caused by the oxide. As a result, the effect of oxides on magnetic properties can be reduced. In addition, by optimizing the content of Cr, the crystallite diameter in the soft magnetic powder can be controlled so as not to be too small or too large. As a result, an increase in the coercive force of the soft magnetic powder can be prevented. In addition, the addition of Cr relatively reduces the content of Si, stabilizing the permeability over a wide frequency range. Accordingly, the DC superimposition characteristics can be enhanced.

A total content of Si, B, and Cr, which is (Si+B+Cr), is set to 1, and a ratio of the total content (B+Cr) of B and Cr to the total content (Si+B+Cr) is set to y.

The y satisfies 0.55≤y≤0.91, preferably satisfies 0.60≤y≤0.90, and more preferably satisfies 0.65≤y≤0.80. Accordingly, a quantitative balance between Si and B and Cr can be achieved. As a result, it is possible to enhance both the oxidation resistance and the permeability of the soft magnetic powder in a well-balanced manner.

When y is less than the lower limit value, the oxidation resistance decreases, and the crystallite diameter becomes too small, resulting in a decrease in permeability. On the other hand, when y is more than the upper limit value, the crystallite diameter becomes too large, resulting in an increase in coercive force.

The ratio of the content of Cr to the total content (B+Cr) is defined as z.

The z satisfies 0.015≤z≤0.185, preferably 0.030≤z≤0.150, and more preferably 0.045≤z≤0.120. Accordingly, a quantitative balance between B and Cr can be achieved. As a result, it is possible to enhance both the oxidation resistance and the permeability of the soft magnetic powder in a well-balanced manner.

When z is less than the lower limit value, the oxidation resistance decreases, and the crystallite diameter becomes too small, resulting in a decrease in permeability. On the other hand, when z is more than the upper limit value, the crystallite diameter becomes too large, resulting in an increase in coercive force.

A content of Si is preferably 1.5 atomic % or more and 14.0 atomic % or less, more preferably 3.0 atomic % or more and 10.0 atomic % or less, and still more preferably 4.0 atomic % or more and 8.0 atomic % or less. Accordingly, it is possible to obtain a soft magnetic powder that can be used to produce a green compact having a lower coercive force and better DC superimposition characteristics.

The content of B is preferably 5.0 atomic % or more and 17.0 atomic % or less, more preferably 7.0 atomic % or more and 16.0 atomic % or less, and still more preferably 9.0 atomic % or more and 13.5 atomic % or less. Accordingly, it is possible to obtain a soft magnetic powder that can be used to produce a green compact having a lower coercive force and better DC superimposition characteristics.

The content of Cr is preferably 0.3 atomic % or more and 2.7 atomic % or less, more preferably 0.5 atomic % or more and 2.2 atomic % or less, and still more preferably 0.8 atomic % or more and 1.8 atomic % or less. Accordingly, it is possible to further enhance the oxidation resistance of the soft magnetic powder and further inhibit the generation of oxides. As a result, the crystallite diameter of the crystal grains contained in each particle can be appropriately controlled.

The soft magnetic powder according to the embodiment may contain impurities in addition to the composition represented by the above-described composition formula FeₓCuₐNb_{b} (Si_{1-y}(B_{1-z}Cr_{z})_{y})_{100-x-a-b}. Examples of the impurities include all elements other than those described above, and a total content of impurities is preferably 0.50 atomic % or less. As long as the content is within the above range, the impurities are less likely to hinder the effect even when the impurities are mixed in, and thus the impurities are allowed to be contained.

The content of each element contained in the impurities is preferably 0.05 atomic % or less. As long as the content is within the above range, the impurities are less likely to hinder the effect, and thus the impurities are allowed to be contained.

Among the impurities, an oxygen content is preferably 1500 ppm or less, and more preferably 800 ppm or less. As long as the oxygen content is within the above range, the generation of oxides that cause a decrease in the density of the molded body can be particularly inhibited.

Although the soft magnetic powder according to the embodiment is described, the composition and the impurities are identified by the following analysis method.

Examples of the analysis method include iron and steel-atomic absorption spectrometry defined in JIS G 1257:2000, iron and steel-ICP emission spectrometry defined in JIS G 1258:2007, iron and steel-spark discharge emission spectrometry defined in JIS G 1253:2002, iron and steel-fluorescent X-ray spectrometry defined in JIS G 1256:1997, and gravimetric, titration and absorption spectrometric methods defined in JIS G 1211 to JIS G 1237.

Specifically, examples thereof include a solid-state optical emission spectrometer manufactured by SPECTRO, in particular a spark discharge optical emission spectrometer, model: SPECTROLAB, type: LAVMB08A, and an ICP device CIROS120 manufactured by Rigaku Corporation.

In particular, when identifying carbon (C) and sulfur (S), an infrared absorption method after combustion in a current of oxygen (combustion in high frequency induction furnace) defined in JIS G 1211:2011 is also used. Specifically, examples thereof include a carbon-sulfur analyzer CS-200 manufactured by LECO Corporation.

When nitrogen (N) and oxygen (O) are identified, methods for determination of nitrogen content for an iron and steel defined in JIS G 1228:1997 and general rules for determination of oxygen in metal materials defined in JIS Z 2613:2006 are also used. Specifically, examples thereof include an oxygen/nitrogen analyzer TC-300/EF-300 manufactured by LECO Corporation, and an oxygen/nitrogen/hydrogen analyzer ONH836 manufactured by LECO Corporation.

### 1.2. Particle Diameter

An average particle diameter of the soft magnetic powder according to the embodiment is 5.0 μm or more and 45.0 μm or less, preferably 7.0 μm or more and 30.0 μm or less, and more preferably 10.0 μm or more and 20.0 μm or less.

By using the soft magnetic powder having such an average particle diameter, a path through which an eddy current flows can be shortened, and thus it is possible to produce a magnetic element in which eddy current loss can be sufficiently reduced. In addition, a filling rate of the soft magnetic powder in the green compact can be increased, making it easier to enhance the permeability and the saturation magnetic flux density of the dust core.

When the soft magnetic powder has an average particle diameter of 10 μm or more, a higher molded body density can be achieved by mixing the soft magnetic powder having an average particle diameter smaller than that of the soft magnetic powder according to the embodiment with the soft magnetic powder according to the embodiment. Accordingly, a saturation magnetic flux density and the permeability of the dust core are likely to be enhanced.

The average particle diameter of the soft magnetic powder refers to a particle diameter D50 when a cumulative frequency is 50% from a small diameter side in a cumulative particle size distribution on a volume basis of the soft magnetic powder obtained using a laser diffraction type particle size distribution measurement device.

When the average particle diameter of the soft magnetic powder is less than the above lower limit value, the soft magnetic powder is too fine, and thus the filling property of the soft magnetic powder may easily decrease. Accordingly, a molding density of the dust core, which may result in a decrease in the permeability and the saturation magnetic flux density of the dust core depending on the composition and mechanical properties of the soft magnetic powder, may decrease. On the other hand, when the average particle diameter of the soft magnetic powder is more than the upper limit value, depending on the composition and the mechanical properties of the soft magnetic powder, the eddy current loss generated within the particles may not be sufficiently reduced, and the iron loss of the magnetic element may increase.

### 1.3. Crystallite Diameter

The soft magnetic powder according to the embodiment has a crystallite diameter of 5.0 nm or more and 20.0 nm or less as measured by an X-ray diffraction method. When the crystallite diameter is within the range, the crystallite diameter of the soft magnetic powder is optimized, so that even when the content of Si, which has the effect of enhancing the permeability, is relatively low, the decrease in the permeability can be prevented. In addition, magnetocrystalline anisotropy in each of crystal grains is easily averaged, and a soft magnetic powder with low coercive force is obtained. Further, it is possible to implement a soft magnetic powder having stable permeability over a wide frequency range. Accordingly, since the magnetic saturation is less likely to occur, it is possible to obtain a soft magnetic powder that can implement a magnetic element having good DC superimposition characteristics and excellent operational stability.

The crystallite diameter of the soft magnetic powder is preferably 6.0 nm or more and 13.0 nm or less, and more preferably 8.0 nm or more and 11.0 nm or less.

The measurement of the crystallite diameter by the X-ray diffraction method is performed by a method in which an X-ray diffraction pattern is obtained for each of the soft magnetic powder and a standard sample, the diffraction line width derived from Fe is estimated, and then the crystallite diameter is calculated by the Scherrer method. The X-ray diffraction pattern obtained for the standard sample is used to estimate the diffraction line width derived from a device. The crystallite diameter calculated from the soft magnetic powder can be corrected based on the diffraction line width.

Each particle constituting the soft magnetic powder according to the embodiment contains crystal grains satisfying the above-described crystallite diameter, but may further contain an amorphous structure. Coexistence of the crystal grains and the amorphous structure can reduce a magnetostriction of the soft magnetic powder. As a result, a soft magnetic powder can be obtained whose permeability is not easily reduced even when the content of Si is low.

### 1.4. Permeability

In the soft magnetic powder according to the embodiment, when the permeability of the first specimen described above is measured at a frequency of 1 MHz, it is preferable that the permeability is 15 or more and less than 21, more preferably 16 or more and less than 20, and still more preferably 17 or more and less than 20.

According to such a configuration, it is considered that the magnetic saturation is less likely to occur over a wide frequency range because the content of Si in the soft magnetic powder is mainly optimized. Therefore, in the magnetic element produced using the soft magnetic powder, when a DC current is superimposed on the coils, a magnetic element having good DC superimposition characteristics can be implemented.

For the measurement of the permeability, an impedance analyzer (4294A, manufactured by Keysight Technologies, Inc.) or the like is used.

In the soft magnetic powder according to the embodiment, when the permeability of the first specimen described above is measured at a frequency of 100 MHz, it is preferable that the permeability is 15 or more and less than 21, more preferably 16 or more and less than 20, and still more preferably 17 or more and less than 20.

According to such a configuration, it is possible to obtain a soft magnetic powder that can be used over a wide frequency range and can implement a magnetic element that is miniaturized.

Further, in the soft magnetic powder according to the embodiment, a reduction rate in permeability when the frequency is increased from 1 MHz to 100 MHz is 3.0% or less as described above, and is preferably 2.5% or less, and more preferably 2.0% or less.

### 1.5. DC Superimposition Characteristics

When the soft magnetic powder according to the embodiment is compacted together with a binder to prepare a ring-shaped second molded body, it is preferable that the DC superimposition characteristics of the second molded body satisfy a predetermined condition. The DC superimposition characteristics are evaluated as follows.

First, an epoxy resin in an amount equivalent to 2.0 mass % of the soft magnetic powder according to the embodiment is mixed with the soft magnetic powder, and the obtained mixture is press-molded at a pressure of 294.2 MPa (3 t/cm²). Accordingly, a ring-shaped second molded body having an outer diameter of 28 mm, an inner diameter of 14 mm, and a thickness of 5 mm is obtained. Next, the obtained second molded body is placed in a resin case, and then a conductive wire having a wire diameter of 1.25 mm is wound around the case 50 times to prepare a second specimen. Next, an AC signal having a frequency of 10 kHz passes through the second specimen, and an inductance when no DC bias current is superimposed is taken as a reference value. Next, the inductance is measured while gradually increasing the DC bias current superimposed on the second specimen. Then, when a measured value decreases to 80% of the reference value (when the measured value decreases to 80% assuming the reference value to be 100%), the DC bias current superimposed on the second specimen is measured. In the present specification, the DC bias current at this time is referred to as a “DC superimposition allowable current” and is used as an index for evaluating the DC superimposition characteristics.

In the soft magnetic powder according to the embodiment, the DC superimposition allowable current is preferably 17 A or more, more preferably 18 A or more and 24 A or less, and still more preferably 19 A or more and 22 A or less. When the DC superimposition allowable current is within the above range, it can be considered that the superposition of a sufficiently high DC bias current is allowable. Therefore, the soft magnetic powder with the DC superimposition allowable current within the above range can implement a magnetic element with sufficiently high DC superimposition characteristics and excellent operational stability.

The DC superimposition allowable current may be more than the upper limit value, but in this case, a degree of difficulty in producing the soft magnetic powder increases, which may cause an increase in production cost and a decrease in production yield.

A DC power supply device may include two DC stabilized power supplies (EX-1500H, manufactured by Takasago Manufacturing Co., Ltd.) connected in parallel. An impedance analyzer (4294A, manufactured by Keysight Technologies) or the like is used as an inductance measurement device.

### 1.6. Coercive Force

The coercive force of the soft magnetic powder according to the embodiment is not particularly limited, and is preferably less than 2.00 [Oe](less than 160 [A/m]), and more preferably 0.10 [Oe] or more and 1.67 [Oe] or less (39.9 [A/m] or more and 133 [A/m] or less). By using the soft magnetic powder having such a small coercive force, it is possible to produce a magnetic element capable of sufficiently reducing hysteresis loss even under a high frequency.

The coercive force of the soft magnetic powder can be measured, for example, by a vibrating sample magnetometer such as TM-VSM1230-MHHL manufactured by Tamakawa Co., Ltd.

### 1.7. Saturation Magnetic Flux Density

The saturation magnetic flux density of the soft magnetic powder according to the embodiment is preferably 1.20 [T] or more, more preferably 1.25 [T] or more, still more preferably 1.28 [T] or more, and particularly preferably 1.30 [T] or more. Accordingly, a magnetic element that is less likely to be saturated even with a high current is obtained.

The saturation magnetic flux density of the soft magnetic powder is measured by, for example, the following method.

First, a true specific gravity p of the soft magnetic powder is measured using a fully automatic gas displacement densitometer, AccuPyc1330, manufactured by Micromeritics Corporation. Next, a maximum magnetization Mm of the soft magnetic powder is measured by a vibrating sample magnetometer, VSM system, TM-VSM1230-MHHL manufactured by Tamakawa Co., Ltd. Then, the saturation magnetic flux density Bs is calculated by the following formula.

$$Bs = 4 π / 10000 \times ρ \times Mm$$

### 1.8. Density of Molded Body

The soft magnetic powder according to the embodiment is mixed with an epoxy resin in an amount equivalent to 2.0 mass % thereof, and the obtained mixture is press-molded at a pressure of 294.2 MPa (3 t/cm²) to give a third molded body having a density of preferably 4.99 g/cm³ or more, and more preferably 5.01 g/cm³ or more and 5.20 g/cm³ or less. When the density of the third molded body is within the above range, an occupancy rate of oxides in the third molded body is sufficiently reduced, and as a result, an occupancy rate of an alloy can be sufficiently ensured. Accordingly, it is possible to further enhance the permeability and the saturation magnetic flux density of the magnetic element.

The soft magnetic powder according to the embodiment may be mixed with other soft magnetic powders or non-soft magnetic powders, and the mixed powder may be used for various applications.

### 2. Method for Producing Soft Magnetic Powder

Next, an example of a method for producing the soft magnetic powder according to the embodiment will be described.

The soft magnetic powder may be a powder produced using any method. Examples of the method for producing the soft magnetic powder include a pulverization method, in addition to various atomization methods such as a water atomization method, a rotary water jet atomization method, and a gas atomization method. Among these, the atomization method is preferably used. According to the atomization method, it is possible to efficiently produce a high-quality metal powder having a particle shape closer to a perfect sphere with less formation of an oxide or the like. Therefore, a metal powder having a smaller specific surface area can be produced using the atomization method.

The atomization method is a method for producing a metal powder by causing a molten metal to collide with a liquid or a gas sprayed at a high speed so as to pulverize and cool the molten metal. In the atomization method, since the molten metal is more spherical in the process of solidification after the molten metal is atomized, a particle closer to a perfect sphere can be produced.

Among these, the water atomization method is a method for producing a metal powder from a molten metal by using a liquid such as water as a cooling liquid, spraying the liquid in an inverted conical shape to converge the liquid to one point, and causing the molten metal to flow down toward the convergence point and to undergo collision.

In addition, the rotary water jet atomization method is a method for manufacturing a metal powder by supplying a cooling liquid along an inner peripheral surface of a cooling cylinder, swirling the cooling liquid along the inner peripheral surface, spraying a jet of a liquid or a gas to a molten metal, and merging the scattered molten metal into the cooling liquid.

Further, the gas atomization method is a method of producing a metal powder from a molten metal by using a gas as a cooling medium, spraying the gas in an inverted conical shape to converge the liquid to one point, and causing the molten metal to flow down toward the convergence point and to undergo collision.

Each of the particles of the metal powder obtained in such a manner has an amorphous structure. By subjecting such metal powder to a crystallization treatment (heat treatment) to be described later, the soft magnetic powder according to the embodiment can be obtained.

The metal powder according to the embodiment is intended to be subjected to the crystallization treatment, and is formed of the same composition and impurities as the soft magnetic powder described above.

For such a metal powder, a differential scanning calorimeter (DSC) curve is obtained by differential scanning calorimetry. A mass of a sample in the differential scanning calorimetry is 20 mg, and a measurement atmosphere is a nitrogen atmosphere.

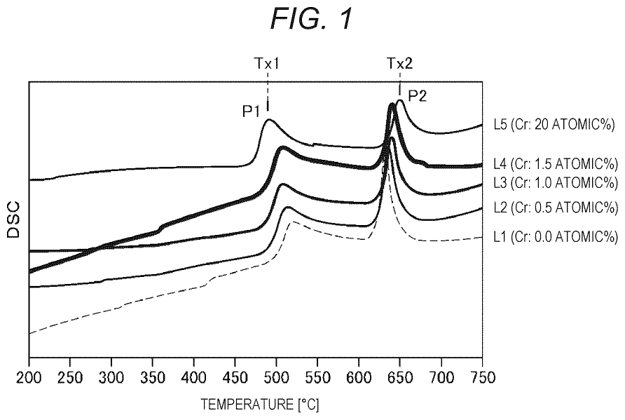

FIG. 1 is an example of a DSC curve obtained from a metal powder to be used in the production of the soft magnetic powder according to the embodiment.

Each of DSC curves L1 to L5 shown in FIG. 1 has a first exothermic peak P1 and a second exothermic peak P2. The second exothermic peak P2 is located at a position at a temperature higher than that of the first exothermic peak P1. The DSC curves L1 to L5 are DSC curves obtained from metal powders in which the content of Cr is changed as shown in FIG. 1. Specifically, the DSC curves L1, L2, L3, L4, and L5 are obtained from metal powders having compositions with the content of Cr of 0.0 atomic %, 0.5 atomic %, 1.0 atomic %, 1.5 atomic %, and 2.0 atomic %. In the metal powder, the content of Fe is 77.0 atomic %, the content of Cu is 1.0 atomic %, and the content of Nb is 3.0 atomic %. The content of B is adjusted so that a total of the content of B and the content of Cr is 13.3 atomic %.

The first exothermic peak P1 is a peak in which a temperature Tx1 of a peak top is in a range of 450° C. or higher and 550° C. or lower. The first exothermic peak P1 is a peak caused by heat generated when the crystal grains of the soft magnetic powder are generated. Therefore, it can be said that the first exothermic peak P1 is a peak due to crystallization required in the production of the soft magnetic powder. According to such crystallization, for example, crystal grains having a body-centered cubic lattice (Bcc-Fe) structure are generated. Hereinafter, the crystal grains having the Bcc-Fe structure are also simply referred to as “crystal grains”.

The second exothermic peak P2 is a peak in which a temperature Tx2 of a peak top is in a range of 600° C. or higher and 700° C. or lower. The second exothermic peak P2 is a peak associated with heat generation that occurs when a crystal structure different from the crystal grains contained in the soft magnetic powder described above is formed. The crystal structure contains, for example, an Fe—B-based alloy as a main component, and causes the soft magnetism of the soft magnetic powder to deteriorate. Therefore, it can be said that the second exothermic peak P2 is a peak due to unnecessary crystal structures in the production of soft magnetic powder. Hereinafter, this will also be referred to as “unnecessary crystal structure”.

Further, in the metal powder according to the embodiment, a temperature difference Tx2-Tx1 between the first exothermic peak P1 and the second exothermic peak P2 is 125° C. or higher and 180° C. or lower. According to such a configuration, the temperature difference is sufficiently ensured, so that when the metal powder is subjected to the heat treatment between the temperature of the first exothermic peak P1 and the temperature of the second exothermic peak P2, it is easy to impart to the metal powder an amount of heat necessary to generate the crystal grains described above. Therefore, it is possible to perform a crystallization treatment at a higher temperature, thereby enabling the crystal grains to grow appropriately while avoiding the generation of unnecessary crystal structures. As a result, it is easy to produce a soft magnetic powder in which the crystallite diameter is controlled within the above-described range.

The temperature difference Tx2-Tx1 between the first exothermic peak P1 and the second exothermic peak P2 is preferably 130° C. or higher and 165° C. or lower, and more preferably 135° C. or higher and 155° C. or lower.

When the temperature difference is less than the lower limit value, when attempting to sufficiently generate crystal grains that are within the above-described range of the crystallite diameter, that is, when performing the heat treatment at a temperature sufficiently higher than the temperature of the first exothermic peak P1, crystallization corresponding to the second exothermic peak P2 may also unintentionally occur. On the other hand, the temperature difference may be more than the upper limit value, but depending on the temperature of the second exothermic peak P2, the temperature of the first exothermic peak P1 may be too low, and therefore, the grain size of the crystal grains may tend to vary, and the crystallite diameter of the generated crystal grains may tend to deviate from the range.

The temperature difference depends on the composition of the metal powder, particularly the content of Cr. As shown in FIG. 1, when the content of Cr changes from 0 atomic % to 2.0 atomic %, the temperature difference also tends to increase accordingly. In addition, it is considered that a state of the amorphous structure in the metal powder is also affected, and for example, when a cooling rate at the time of forming the amorphous structure is low, the temperature difference tends to be narrow. Therefore, when producing the metal powder, a production method that provides a high cooling rate from a molten metal, such as the rotary water jet atomization method among the atomization methods, is preferably used.

The metal powder as described above is subjected to a crystallization treatment (heat treatment). Accordingly, at least a part of the amorphous structure is crystallized to form the crystal grains.

The crystallization treatment can be performed by subjecting the soft magnetic powder containing the amorphous structure to the heat treatment. The temperature of the heat treatment is not particularly limited, and is preferably 520° C. or higher and 640° C. or lower, more preferably 530° C. or higher and 630° C. or lower, and still more preferably 540° C. or higher and 620° C. or lower. A time of the heat treatment, which is a time for maintaining the above temperature, is preferably 1 minute or longer and 180 minutes or shorter, more preferably 3 minutes or longer and 120 minutes or shorter, and still more preferably 5 minutes or longer and 60 minutes or shorter. By setting the temperature and the time of the heat treatment within the above ranges, it is possible to produce crystal grains having a more appropriate and uniform crystallite diameter.

When the temperature or time of the heat treatment is below the lower limit value, the crystallization may be insufficient depending on the composition or the like of the soft magnetic powder, and the crystallite diameter may be excessively small, or the uniformity of the crystallite diameter may be deteriorated. On the other hand, when the temperature or the time of the heat treatment is more than the upper limit value, the crystallization may proceed excessively depending on the composition or the like of the soft magnetic powder, and the crystallite diameter may be excessively large, or the uniformity of the crystallite diameter may be deteriorated.

An atmosphere in the crystallization treatment is not particularly limited, and is preferably an inert gas atmosphere such as nitrogen or argon, a reducing gas atmosphere such as hydrogen or ammonia decomposition gas, or a reduced-pressure atmosphere thereof. Accordingly, the crystallization can be achieved while reducing oxidation of the metal, and therefore, a soft magnetic powder having excellent magnetic properties can be obtained.

An oxygen concentration in the atmosphere during the crystallization treatment affects an amount of oxides produced. The oxygen concentration in the crystallization treatment atmosphere is preferably 1000 ppm or less, more preferably 5 ppm or more and 500 ppm or less, and still more preferably 10 ppm or more and 200 ppm or less in terms of volume ratio. Accordingly, generation of oxides can be reduced, and the soft magnetic powder capable of producing a high-density green compact can be obtained.

A temperature drop rate in the crystallization treatment is 1° C./min or more and 100° C./min or less, more preferably 2° C./min or more and 30° C./min or less, and still more preferably 4° C./min or more and 20° C./min or less. By setting the temperature drop rate within the above range, it is easier to control the crystallite diameter of the soft magnetic powder within the above range. In addition, the variation in crystallite diameter can be prevented. When the temperature drop rate is less than the lower limit value, the crystallite diameter of the soft magnetic powder is likely to be excessively large, whereas when the temperature drop rate is more than the upper limit value, the crystallite diameter of the soft magnetic powder may greatly vary.

In this manner, the soft magnetic powder according to the embodiment can be produced.

The produced soft magnetic powder may be classified as necessary. Examples of classification methods include dry classification such as sieving classification, inertial classification, and centrifugal classification, and wet classification such as sedimentation classification.

If necessary, an insulating film may be formed on a surface of each particle of the obtained soft magnetic powder. Examples of a constituent material of the insulating film include inorganic materials such as phosphates such as magnesium phosphate, calcium phosphate, zinc phosphate, manganese phosphate, and cadmium phosphate, and silicates such as sodium silicate, ceramic materials such as silica, alumina, magnesia, zirconia, and titania, and glass materials such as borosilicate glass and silica glass.

### 3. Dust Core and Magnetic Element

Next, the dust core and the magnetic element according to the embodiment will be described.

The magnetic element according to the embodiment can be applied to various magnetic elements including a magnetic core, such as choke coils, an inductor, a noise filter, a reactor, a transformer, a motor, an actuator, an electromagnetic valve, and a generator. The dust core according to the embodiment can be applied to a magnetic core provided to these magnetic elements.

Hereinafter, two types of coil components will be representatively described as an example of the magnetic element.

### 3.1. Toroidal Type

First, a toroidal type coil component, which is the magnetic element according to the embodiment, will be described.

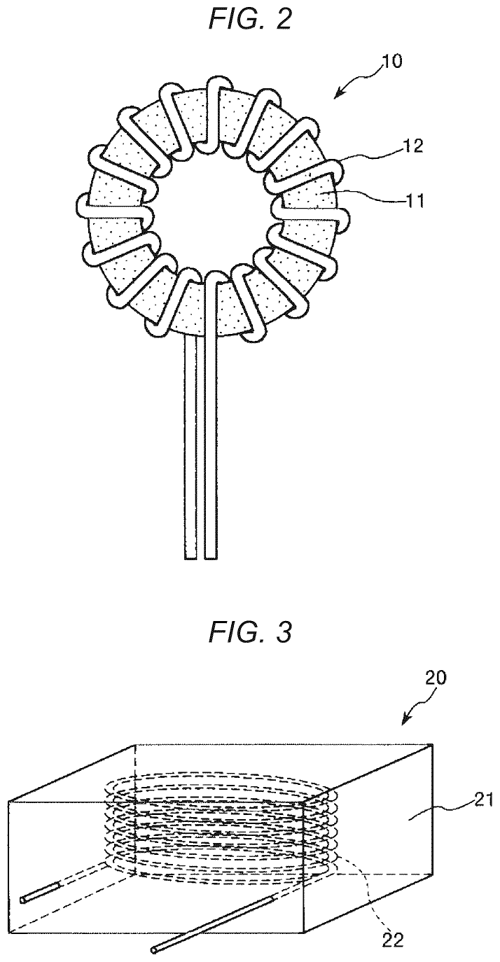

FIG. 2 is a plan view schematically showing a toroidal type coil component 10. The coil component 10 shown in FIG. 2 includes a ring-shaped dust core 11 and a conductive wire 12 wound around the dust core 11.

The dust core 11 is obtained by mixing the soft magnetic powder according to the embodiment with a binder and compacting the obtained mixture. Since the dust core 11 is a green compact containing the soft magnetic powder according to the embodiment, a molding density is high and the coercive force and the DC superimposition characteristics are excellent. Therefore, when the coil component 10 including the dust core 11 is mounted in an electronic device or the like, the electronic device or the like can have high performance and a small size.

Examples of a constituent material of the binder used for producing the dust core 11 include organic materials such as silicone-based resins, epoxy-based resins, phenol-based resins, polyamide-based resins, polyimide-based resins, and polyphenylene sulfide-based resins, and inorganic materials such as phosphates such as magnesium phosphate, calcium phosphate, zinc phosphate, manganese phosphate, and cadmium phosphate, and silicates such as sodium silicate.

Examples of a constituent material of the conductive wire 12 include a material having high conductivity, for example, a metal material including Cu, Al, Ag, Au, and Ni. An insulating coating film is provided on a surface of the conductive wire 12 as necessary.

A shape of the dust core 11 is not limited to the ring shape shown in FIG. 2, and may be, for example, a shape in which a part of the ring is missing, or a shape in which a shape in a longitudinal direction is linear.

The dust core 11 may contain, as necessary, a soft magnetic powder other than the soft magnetic powder according to the embodiment described above, or a non-magnetic powder.

### 3.2. Closed Magnetic Circuit Type

Next, a closed magnetic circuit type coil component, which is the magnetic element according to the embodiment, will be described.

FIG. 3 is a transparent perspective view schematically showing a closed magnetic circuit type coil component 20.

Hereinafter, the closed magnetic circuit type coil component 20 will be described. In the following description, differences from the toroidal type coil component 10 will mainly be described, and description of similar matters will be omitted.

The coil component 20 shown in FIG. 3 is formed by embedding a conductive wire 22 formed in a coil-like shape inside a dust core 21. Since the dust core 21 is a green compact containing the soft magnetic powder according to the embodiment, a molding density is high and the coercive force, the permeability, and the DC superimposition characteristics are excellent. Therefore, when the coil component 20 including the dust core 21 is mounted in an electronic device or the like, the electronic device or the like can have high performance and a small size.

The dust core 21 may contain, as necessary, a soft magnetic powder other than the soft magnetic powder according to the embodiment described above, or a non-magnetic powder.

### 4. Electronic Device

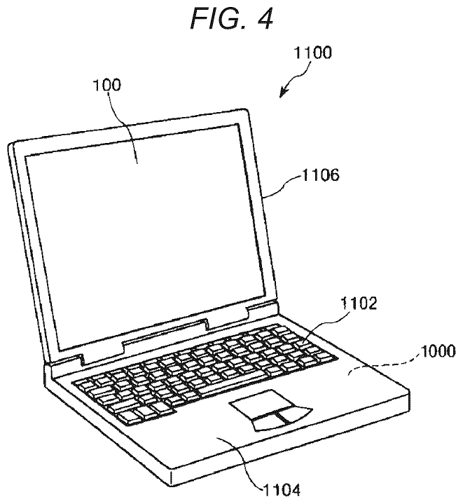

Next, the electronic device including the magnetic element according to the embodiment will be described with reference to FIGS. 4 to 6.

FIG. 4 is a perspective view showing a configuration of a mobile personal computer 1100 which is an electronic device according to the embodiment. The personal computer 1100 shown in FIG. 4 includes a main body 1104 including a keyboard 1102 and a display unit 1106 including a display 100. The display unit 1106 is pivotally supported by the main body 1104 via a hinge structure. Such the personal computer 1100 includes therein a magnetic element 1000 such as a choke coil, an inductor, or a motor for a switching power supply.

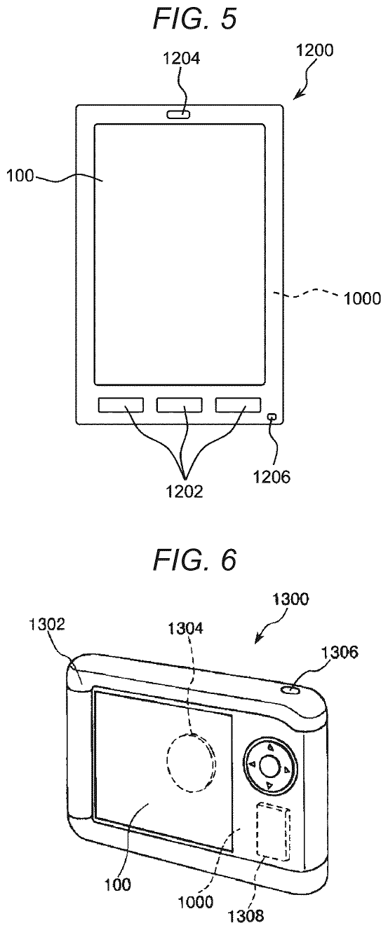

FIG. 5 is a plan view showing a configuration of a smartphone 1200 which is an electronic device according to the embodiment. The smartphone 1200 shown in FIG. 5 includes a plurality of operation buttons 1202, an earpiece 1204, and a mouthpiece 1206. The display 100 is disposed between the operation buttons 1202 and the earpiece 1204. Such the smartphone 1200 includes therein the magnetic element 1000 such as an inductor, a noise filter, or a motor.

FIG. 6 is a perspective view showing a configuration of a digital still camera 1300 which is an electronic device according to the embodiment. The digital still camera 1300 photoelectrically converts an optical image of a subject with an imaging element such as a charge coupled device (CCD) to generate an imaging signal.

The digital still camera 1300 shown in FIG. 6 includes the display 100 provided at a rear surface of a case 1302. The display 100 functions as a finder which displays a subject as an electronic image. A light receiving unit 1304 including an optical lens, a CCD, and the like is provided on a front surface side of the case 1302, that is, on a back surface side in the drawing.

When a photographer confirms a subject image displayed on the display 100 and presses a shutter button 1306, a CCD imaging signal at this time is transferred to and stored in a memory 1308. Such the digital still camera 1300 also includes therein the magnetic element 1000 such as an inductor or a noise filter.

Examples of the electronic device according to the embodiment include, in addition to the personal computer 1100 in FIG. 4, the smartphone 1200 in FIG. 5, and the digital still camera 1300 in FIG. 6, a mobile phone, a tablet terminal, a watch, inkjet discharge apparatuses such as an inkjet printer, a laptop personal computer, a television, a video camera, a video tape recorder, a car navigation apparatus, a pager, an electronic notebook, an electronic dictionary, a calculator, an electronic game console, a word processor, a workstation, a videophone, a security television monitor, electronic binoculars, a POS terminal, medical devices such as an electronic thermometer, a blood pressure meter, a blood glucose meter, an electrocardiogram measurement apparatus, an ultrasonic diagnostic apparatus, and an electronic endoscope, a fish finder, various measuring devices, instruments for a vehicle, an aircraft, and a ship, vehicle control devices such as an automobile control device, an aircraft control device, a railway vehicle control device, and a ship control device, and a flight simulator.

Such an electronic device includes the magnetic element according to the embodiment. Accordingly, effects of the magnetic element can be provided, and the electronic device can have high performance and a small size.

### 5. Effects of Embodiment

As described above, a soft magnetic powder according to the embodiment includes: impurities and a composition represented by a composition formula FeₓCuₐNb_{b}(Si_{1-y}(B_{1-z}Cr_{z})_{y})_{100-x-a-b} in terms of atomic ratio, where a, b, x, y, and z satisfy 0.3≤a≤2.0, 2.0≤b≤4.0, 75.5≤x≤79.5, 0.55≤y≤0.91, and 0.015≤z≤0.185. The soft magnetic powder has an average particle diameter of 5.0 μm or more and 45.0 μm or less, and has a crystallite diameter of 5.0 nm or more and 20.0 nm or less, as measured by an X-ray diffraction method.

In addition, when the soft magnetic powder according to the embodiment is mixed with 2.0 mass % of an epoxy resin and an obtained mixture is press-molded at a pressure of 294.2 MPa (3 t/cm²) to obtain a ring-shaped first molded body having an outer diameter of 14 mm, an inner diameter of 8 mm, and a thickness of 3 mm, and then a conductive wire having a wire diameter of 0.6 mm is wound seven times around the first molded body to prepare a first specimen, a reduction rate d of permeability is 3.0% or less, as represented by the following equation:

$$d = \vert {μ}_{1} - {μ}_{100} \vert / {μ}_{1} \times 100$$

[In the above equation, μ₁ is permeability of the first specimen measured at a frequency of 1 MHz, and μ₁₀₀ is permeability of the first specimen measured at a frequency of 100 MHz.]

According to such a configuration, a soft magnetic powder that can be used to produce a green compact having excellent oxidation resistance, density, coercive force, and DC superimposition characteristics can be obtained.

In the soft magnetic powder according to the embodiment, the permeability μ₁ is 15 or more and less than 21.

According to such a configuration, it is considered that the magnetic saturation is less likely to occur because the content of Si in the soft magnetic powder is mainly optimized. Therefore, it is possible to obtain a soft magnetic powder that can implement a magnetic element having good DC superimposition characteristics.

In the soft magnetic powder according to the embodiment, when the soft magnetic powder is mixed with 2.0 mass % of an epoxy resin and the obtained mixture is press-molded at the pressure of 294.2 MPa (3 t/cm²) to obtain a ring-shaped second molded body having an outer diameter of 28 mm, an inner diameter of 14 mm, and a thickness of 5 mm, and then a conductive wire having a wire diameter of 1.25 mm is wound 50 times around the second molded body to prepare a second specimen, a DC superimposition allowable current measured for the second specimen is 17 A or more. The DC superimposition allowable current is a DC bias current superimposed on the second specimen when an AC signal with a frequency of 10 kHz passes through the second specimen and an inductance when no DC bias current is superimposed is taken as a reference value, and when the inductance measured while gradually increasing the DC bias current superimposed on the second specimen falls to 80% of the reference value.

According to such a configuration, a soft magnetic powder that can implement a magnetic element having sufficiently high DC superimposition characteristics and excellent operational stability.

In the soft magnetic powder according to the embodiment, a content of Si is 4.0 atomic % or more and 8.0 atomic % or less, a content of B is 9.0 atomic % or more and 13.5 atomic % or less, and a content of Cr is 0.5 atomic % or more and 2.2 atomic % or less.

According to such a configuration, it is possible to obtain a soft magnetic powder that can be used to produce a green compact having a lower coercive force and better DC superimposition characteristics. In addition, it is possible to further enhance the oxidation resistance of the soft magnetic powder and further inhibit the generation of oxides. As a result, the crystallite diameter of the crystal grains contained in each particle can be appropriately controlled.

In the soft magnetic powder according to the embodiment, an oxygen content is 1500 ppm or less.

According to such a configuration, the generation of oxides that cause a decrease in the density of the molded body can be particularly inhibited.

In the soft magnetic powder according to the embodiment, a saturation magnetic flux density Bs [T] determined by 4π/10000×ρ×Mm=Bs is 1.20 [T] or more, where Mm [emu/g] is a maximum magnetization measured using a vibrating sample magnetometer, and ρ [g/cm³] is a true density.

According to such a configuration, a magnetic element that is less likely to be saturated even with a high current can be obtained.

The dust core according to the embodiment includes the soft magnetic powder according to the embodiment.

According to such a configuration, a dust core having a good density, coercive force and DC superimposition characteristics can be obtained.

The magnetic element according to the embodiment includes the dust core according to the embodiment.

According to such a configuration, a magnetic element that can achieve high performance and a small size of an electronic device and the like that is mounted in the magnetic element can be obtained.

The electronic device according to the embodiment includes the magnetic element according to the embodiment.

According to such a configuration, it is possible to obtain an electronic device having high performance and a small size.

The soft magnetic powder, the metal powder, the dust core, the magnetic element, and the electronic device of the present disclosure are described hereinabove based on the preferred embodiments, but the present disclosure is not limited thereto.

For example, in the above embodiment, a green compact such as a dust core is described as an example of an application of the soft magnetic powder of the present disclosure, and the application example is not limited thereto, and may be, for example, a magnetic fluid and a magnetic device such as a magnetic head. In addition, shapes of the dust core and the magnetic element are not limited to those shown in the drawings, and any shapes may be adopted.

### EXAMPLES

Next, specific examples of the disclosure will be described.

### 6. Preparation of Soft Magnetic Powder

### 6.1. Sample No. 1

First, a raw material was melted in a high-frequency induction furnace and pulverized by a rotary water jet atomization method to obtain a metal powder.

Then, the metal powder thus obtained was subjected to the crystallization treatment of performing heating in a nitrogen atmosphere. Heating temperatures in the heat treatment are as shown in Table 1. The temperature drop rate after heating was 10° C./min, and an oxygen concentration in the atmosphere of the crystallization treatment was 100 ppm. The heating temperatures shown in Table 1 are determined in advance by searching for the heating temperature at which the coercive force of the soft magnetic powder becomes minimum.

Next, classification was carried out using an air classifier. Accordingly, a soft magnetic powder of Sample No. 1 was obtained. Table 1 shows the composition of the obtained soft magnetic powder, the structure of the metal powder before the heat treatment, the crystallization temperature of the metal powder, and the heating temperature of the heat treatment.

### 6.2. Sample Nos. 2 to 16

Soft magnetic powders were obtained in the same manner as in Sample No. 1 except that production conditions of the soft magnetic powders were changed as shown in Table 1.

The soft magnetic powder of sample No. 16 was not subjected to the heat treatment.

TABLE 1

| | | Composition of soft magnetic powder | | | | | | | | | Structure | Crystallization | | | |
|---|---|---|---|---|---|---|---|---|---|---|---|---|---|---|---|
| | | | | | | | | | (B + | | of metal | temperature of | | | Heat |
| | | | | | | | | | Cr)/(Si + | Cr/(B + | powder | metal powder | | | treatment |
| | | Fe | Cu | Nb | | | | | B + Cr) | Cr) | before | | | Tx2 − | Heating |
| Sample | | x | a | b | Si | B | Cr | Total | y | z | heat | Tx1 | Tx2 | Tx1 | temperature |
| No. | Classification | Atomic % | | | | | | | — | — | treatment | ° C. | ° C. | ° C. | ° C. |
| No. 1 | Comparative | 70.7 | 0.8 | 5.0 | 15.0 | 8.0 | 0.5 | 100.0 | 0.36 | 0.059 | Non- | 470 | 590 | 120 | 580 |
| | Example | | | | | | | | | | crystalline | | | | |
| No. 2 | Example | 76.0 | 1.0 | 3.0 | 8.0 | 10.8 | 1.2 | 100.0 | 0.60 | 0.100 | Non- | 490 | 620 | 130 | 610 |
| | | | | | | | | | | | crystalline | | | | |
| No. 3 | Comparative | 77.0 | 1.0 | 3.0 | 5.7 | 13.2 | 0.1 | 100.0 | 0.70 | 0.008 | Non- | 499 | 619 | 120 | 570 |
| | Example | | | | | | | | | | crystalline | | | | |
| No. 4 | Example | 77.0 | 1.0 | 3.0 | 5.7 | 13.0 | 0.3 | 100.0 | 0.70 | 0.023 | Non- | 494 | 621 | 127 | 580 |
| | | | | | | | | | | | crystalline | | | | |
| No. 5 | Example | 77.0 | 1.0 | 3.0 | 5.7 | 12.8 | 0.5 | 100.0 | 0.70 | 0.038 | Non- | 491 | 622 | 131 | 590 |
| | | | | | | | | | | | crystalline | | | | |
| No. 6 | Example | 77.0 | 1.0 | 3.0 | 5.7 | 12.3 | 1.0 | 100.0 | 0.70 | 0.075 | Non- | 486 | 626 | 140 | 600 |
| | | | | | | | | | | | crystalline | | | | |
| No. 7 | Example | 77.0 | 1.0 | 3.0 | 5.7 | 11.8 | 1.5 | 100.0 | 0.70 | 0.113 | Non- | 487 | 627 | 140 | 610 |
| | | | | | | | | | | | crystalline | | | | |
| No. 8 | Example | 77.0 | 1.0 | 3.0 | 5.7 | 11.3 | 2.0 | 100.0 | 0.70 | 0.150 | Non- | 474 | 636 | 162 | 600 |
| | | | | | | | | | | | crystalline | | | | |
| No. 9 | Example | 77.0 | 1.0 | 3.0 | 5.7 | 10.9 | 2.4 | 100.0 | 0.70 | 0.180 | Non- | 468 | 642 | 174 | 590 |
| | | | | | | | | | | | crystalline | | | | |
| No. 10 | Comparative | 77.0 | 1.0 | 3.0 | 5.7 | 10.3 | 3.0 | 100.0 | 0.70 | 0.226 | Non- | 463 | 648 | 185 | 570 |
| | Example | | | | | | | | | | crystalline | | | | |
| No. 11 | Comparative | 77.0 | 1.0 | 3.0 | 1.5 | 16.5 | 1.0 | 100.0 | 0.92 | 0.057 | Non- | 460 | 640 | 180 | 570 |
| | Example | | | | | | | | | | crystalline | | | | |
| No. 12 | Example | 78.0 | 1.2 | 2.7 | 4.5 | 12.1 | 1.5 | 100.0 | 0.75 | 0.110 | Non- | 490 | 628 | 138 | 610 |
| | | | | | | | | | | | crystalline | | | | |
| No. 13 | Example | 78.0 | 1.0 | 3.0 | 1.8 | 14.7 | 1.5 | 100.0 | 0.90 | 0.093 | Non- | 491 | 618 | 127 | 610 |
| | | | | | | | | | | | crystalline | | | | |
| No. 14 | Example | 79.0 | 0.8 | 3.5 | 1.7 | 13.8 | 1.2 | 100.0 | 0.90 | 0.080 | Non- | 493 | 623 | 130 | 600 |
| | | | | | | | | | | | crystalline | | | | |
| No. 15 | Comparative | 73.5 | 1.0 | 3.0 | 13.5 | 9.0 | 0.0 | 100.0 | 0.40 | 0.000 | Non- | 480 | 600 | 120 | 600 |
| | Example | | | | | | | | | | crystalline | | | | |
| No. 16 | Comparative | 80.0 | 1.0 | 3.0 | 1.6 | 13.4 | 1.0 | 100.0 | 0.90 | 0.069 | Crystal | — | — | — | — |
| | Example | | | | | | | | | | | | | | |

In Table 1 and Table 2 shown later, among the soft magnetic powders of respective sample Nos., those corresponding to the present disclosure are designated as “Examples”, and those not corresponding to the present disclosure are designated as “Comparative Examples”

### 7. Evaluation for Soft Magnetic Powder and Molded Body

### 7.1. Average Particle Diameter of Soft Magnetic Powder

The average particle diameter of the soft magnetic powder of each of Examples and Comparative Examples was measured. Measurement results are shown in Table 2.

### 7.2. Crystallite Diameter of Soft Magnetic Powder

The crystallite diameter of the soft magnetic powder of each of Examples and Comparative Examples was measured by an X-ray diffraction method. Measurement results are shown in Table 2.

### 7.3. Oxygen Content of Soft Magnetic Powder

The oxygen content of the soft magnetic powder of each of Examples and Comparative Examples was measured. The oxygen content was measured using an oxygen and nitrogen and hydrogen analyzer, ONH836, manufactured by LECO Corporation. Measurement results are shown in Table 2.

### 7.4. Coercive Force of Soft Magnetic Powder

The coercive force of the soft magnetic powder of each of Examples and Comparative Examples was measured using the above method. Then, the measured coercive force was evaluated in view of the following evaluation criteria. Evaluation results are shown in Table 2.
A: The coercive force is less than 0.90 Oe.
B: The coercive force is 0.90 Oe or more and less than 1.33 Oe.
C: The coercive force is 1.33 Oe or more and less than 1.67 Oe.
D: The coercive force is 1.67 Oe or more and less than 2.00 Oe.
E: The coercive force is 2.00 Oe or more and less than 2.33 Oe.
F: The coercive force is 2.33 Oe or more.

### 7.5. Saturation Magnetic Flux Density of Soft Magnetic Powder

The saturation magnetic flux density of the soft magnetic powder obtained in each of Examples and Comparative Examples was calculated by the above-described method. Calculation results are shown in Table 2.

### 7.6. Density of Molded Body

The density of a molded body produced using the soft magnetic powder of each of Examples and Comparative Examples was measured by the above-described method. Then, the measured density of the molded body was evaluated in view of the following evaluation criteria. Measurement results are shown in Table 2.
A: The density of the molded body is 5.01 g/cm³ or more.
B: The density of the molded body is 4.99 g/cm³ or more and less than 5.01 g/cm³.
C: The density of the molded body is less than 4.99 g/cm³.

### 7.7. Permeability of Molded Body

For the molded body produced using the soft magnetic powder obtained in each of Examples and Comparative Examples, the permeability was measured at frequencies of 1 MHz and 100 MHz by the above-described method. In addition, a reduction rate in the permeability when the frequency was increased from 1 MHz to 100 MHz was calculated. Measurement results and calculation results are shown in Table 2.

### 7.8. DC Superimposition Characteristics of Molded Body

A DC superimposition allowable current of a molded body produced using the soft magnetic powder obtained in each of Examples and Comparative Examples was measured by the above-described method. Then, a measurement result was compared to the following evaluation criteria to evaluate the DC superimposition characteristics. Evaluation results are shown in Table 2.
A: The DC superimposition characteristics are particularly good (DC superimposition allowable current is 19 A or more and 22 A or less).
B: The DC superimposition characteristics are good (DC superimposition allowable current is 18 A or more and less than 19 A, or more than 22 A and less than 24 A).
C: The DC superimposition characteristics are somewhat good (DC superimposition allowable current is 17 A or more but less than 18 A or more than 24 A).
D: The DC superimposition characteristics are poor (DC superimposition allowable current is less than 17 A).

TABLE 2

| | | Evaluation result of soft magnetic powder | | | | | Evaluation result of molded body | | | | |
|---|---|---|---|---|---|---|---|---|---|---|---|
| | | | | | | Saturation | Density | | | | |
| | | Average | | | | magnetic | of | Permeability | | | DC |
| | | particle | Crystallite | Oxygen | Coercive | flux | molded | 1 | 100 | Reduction | superimposition |
| Sample | | diameter | diameter | content | force | density | body | MHz | MHz | rate | characteristics |
| No. | Classification | μm | nm | ppm | — | T | — | — | — | % | — |
| No. 1 | Comparative | 20.0 | 9.5 | 1025 | C | 0.99 | C | 17.8 | 17.4 | 2.2 | D |
| | Example | | | | | | | | | | |
| No. 2 | Example | 14.5 | 9.3 | 630 | A | 1.29 | A | 19.1 | 18.8 | 1.6 | B |
| No. 3 | Comparative | 16.8 | 8.1 | 945 | B | 1.26 | C | 20.1 | 19.9 | 1.0 | C |
| | Example | | | | | | | | | | |
| No. 4 | Example | 10.2 | 8.5 | 860 | B | 1.31 | B | 18.7 | 18.4 | 1.6 | B |
| No. 5 | Example | 9.2 | 9.2 | 795 | B | 1.32 | B | 19.2 | 18.9 | 1.6 | A |
| No. 6 | Example | 11.5 | 9.7 | 659 | A | 1.33 | A | 19.4 | 19.1 | 1.5 | A |
| No. 7 | Example | 13.9 | 10.5 | 584 | A | 1.34 | A | 19.6 | 19.3 | 1.5 | A |
| No. 8 | Example | 19.6 | 8.2 | 521 | B | 1.33 | A | 18.6 | 18.3 | 1.6 | A |
| No. 9 | Example | 25.6 | 7.8 | 499 | C | 1.31 | A | 18.4 | 18.1 | 1.6 | B |
| No. 10 | Comparative | 10.9 | 5.5 | 480 | E | 1.29 | A | 17.4 | 17.0 | 2.3 | C |
| | Example | | | | | | | | | | |
| No. 11 | Comparative | 13.3 | 4.8 | 400 | B | 1.19 | A | 17.0 | 16.6 | 2.4 | C |
| | Example | | | | | | | | | | |
| No. 12 | Example | 38.0 | 10.3 | 590 | A | 1.35 | A | 19.5 | 19.2 | 1.5 | A |
| No. 13 | Example | 15.8 | 9.8 | 602 | B | 1.36 | A | 19.4 | 19.1 | 1.5 | A |
| No. 14 | Example | 32.0 | 9.5 | 623 | C | 1.37 | A | 19.3 | 19.0 | 1.6 | B |
| No. 15 | Comparative | 15.3 | 9.4 | 1860 | C | 1.06 | C | 20.5 | 20.3 | 1.0 | D |
| | Example | | | | | | | | | | |
| No. 16 | Comparative | 19.0 | 25.0 | 1650 | F | 1.32 | C | 19.5 | 18.9 | 3.1 | D |
| | Example | | | | | | | | | | |

As shown in Table 2, in the soft magnetic powder of each Example, even when the content of Fe is high, the oxidation resistance is good and the oxygen content is kept relatively low. It is also recognized that the soft magnetic powder of each Example had a low coercive force. Further, the molded body produced using the soft magnetic powder of each of Examples has good density and DC superimposition characteristics.

What is claimed is:

1. A soft magnetic powder comprising:
impurities and a composition represented by a composition formula FeₓCuₐNb_{b} (Si_{1-y}(B_{1-z}Cr_{z})_{y})_{100-x-a-b} in terms of atomic ratio, where a, b, x, y, and z satisfy 0.3≤a≤2.0, 2.0≤b≤4.0, 75.5≤x≤79.5, 0.55≤y≤0.91, and 0.015≤z≤0.185, wherein
the soft magnetic powder has an average particle diameter of 5.0 μm or more and 45.0 μm or less, and a crystallite diameter of 5.0 nm or more and 20.0 nm or less, as measured by an X-ray diffraction method, and
when the soft magnetic powder is mixed with 2.0 mass % of an epoxy resin and an obtained mixture is press-molded at a pressure of 294.2 MPa (3 t/cm²) to obtain a ring-shaped first molded body having an outer diameter of 14 mm, an inner diameter of 8 mm, and a thickness of 3 mm, and then a conductive wire having a wire diameter of 0.6 mm is wound seven times around the first molded body to prepare a first specimen, a reduction rate d of permeability is 3.0% or less, as represented by the following equation:
$$d = \vert {μ}_{1} - {μ}_{100} \vert / {μ}_{1} \times 100$$
in the above equation, μ₁ is permeability of the first specimen measured at a frequency of 1 MHz, and μ₁₀₀ is permeability of the first specimen measured at a frequency of 100 MHz.

2. The soft magnetic powder according to claim 1, wherein
the permeability μ₁ is 15 or more and less than 21.

3. The soft magnetic powder according to claim 1, wherein
when the soft magnetic powder is mixed with 2.0 mass % of an epoxy resin and the obtained mixture is press-molded at a pressure of 294.2 MPa (3 t/cm²) to obtain a ring-shaped second molded body having an outer diameter of 28 mm, an inner diameter of 14 mm, and a thickness of 5 mm, and then a conductive wire having a wire diameter of 1.25 mm is wound 50 times around the second molded body to prepare a second specimen, an AC signal having a frequency of 10 kHz passes through the second specimen, and an inductance when no DC bias current is superimposed is taken as a reference value, when the inductance measured while gradually increasing the DC bias current superimposed on the second specimen falls to 80% of the reference value, the DC bias current superimposed on the second specimen is 17 A or more.

4. The soft magnetic powder according to claim 1, wherein
a content of Si is 4.0 atomic % or more and 8.0 atomic % or less,
a content of B is 9.0 atomic % or more and 13.5 atomic % or less, and
a content of Cr is 0.5 atomic % or more and 2.2 atomic % or less.

5. The soft magnetic powder according to claim 1, wherein
an oxygen content is 1500 ppm or less.

6. The soft magnetic powder according to claim 1, wherein
a saturation magnetic flux density Bs [T] determined by 4π/10000×ρ×Mm=Bs is 1.20 [T] or more, where Mm [emu/g] is a maximum magnetization measured using a vibrating sample magnetometer, and ρ [g/cm³] is a true density.

7. A dust core comprising:
the soft magnetic powder according to claim 1.

8. A magnetic element comprising:
the dust core according to claim 7.

9. An electronic device comprising:
the magnetic element according to claim 8.
